(19) United States
(12) Patent Application Publication
(10) Pub. No.: US 2010/0260020 A1
(43) Pub. Date: Oct. 14, 2010

(54) INFORMATION PROCESSING APPARATUS, INFORMATION PROCESSING SYSTEM, INFORMATION PROCESSING METHOD, AND PROGRAM

(75) Inventors: Kouichi UCHIMURA, Kanagawa (JP); Yoshikazu TAKASHIMA, Culver City, CA (US)

Correspondence Address: OBLON, SPIVAK, MCCLELLAND MAIER & NEUSTADT, L.L.P., 1940 DUKE STREET, ALEXANDRIA, VA, 22314, US

(73) Assignees: SONY CORPORATION, Tokyo (JP); SONY PICTURES ENTERTAINMENT, INC., CULVER CITY, CA (US)

(21) Appl. No.: 12/423,324

(22) Filed: Apr. 14, 2009

(51) Int. Cl. G11B 20/00

(52) U.S. Cl. 369/47.15; G9B/20

(57) ABSTRACT

An information processing apparatus includes a data processing section configured to generate data that is capable of being played back using general playback control information containing clip information defining the number of playback packets. The data processing section generates a data file in which data containing a number of playback packets, the number matching the defined number of playback packets, is contained as playback data associated with the clip information.

### BACKGROUND OF THE INVENTION

1. Field of the Invention

The present invention relates to information processing apparatuses, information processing systems, information processing methods, and programs. More particularly, the present invention relates to an information processing apparatus, an information processing system, an information processing method, and a program which perform processing for generating addition data associated with content stored on an information recording medium, such as a Blu-ray Disc® or a DVD (digital versatile disc).

2. Description of the Related Art

Various types of software data (which are hereinafter referred to as “content”), such as audio data of music and so on, image data of movies and so on, game programs, and various application programs, can be stored on a disk-shaped information recording medium, such as a Blu-ray Disc or a DVD. In particular, a Blu-ray Disc® that utilizes blue laser light is a high-density recordable disc and is capable of recording a large amount of video content and so on as high-quality data.

Content stored on such a disc can be played back and used through loading of the disc into, for example, a playback apparatus, such as a PC (personal computer) or a disc player.

A Blu-ray Disc® standard also defines usage control for a case in which auxiliary data associated with content (e.g., caption data and dubbed data associated with movie content) stored on a disc and other content of various moving images, still images, and so on (such as service data, previews, and advertisements) associated with the content are used through downloading from a server as addition data.

For example, Japanese Patent No. 3959735 and Japanese Unexamined Patent Application Publication No. 2003-140662 disclose a content-using system that obtains addition data from a server, records the obtained addition data to a local storage (such as a hard disk), and plays back the addition data in conjunction with content stored on a disc.

When a user apparatus plays back content stored on a disc (such as a Blu-ray Disc®) and addition data stored on a local storage section (such as a hard disk) in conjunction with each other, the user apparatus sets a virtual package in which the content stored on the disc and the content stored on the local storage section are merged and further construct a virtual file system (VFS) to perform playback processing. The virtual-file-system-based playback processing allows for playback as if the playback processing were performed from a single medium.

During the virtual-file-system construction processing, the user apparatus performs processing for converting the file names of the addition data stored on the local storage section into file names for setting the virtual file system. The local storage section stores various types of addition data supplied from various content-providing servers.

The virtual-file-system construction processing involves processing for converting the file names on the local storage section into file names on the virtual file system. In order to perform the file-name conversion processing, the user apparatus holds a file-name conversion table. The file-name conversion table is called a “binding unit manifest file (BUMF)”.

In addition, in order to stringently perform usage management of the addition data on the user apparatus, the user apparatus stores a file-tampering verification data (binding unit signature file (BUSF)), which is s signature setting file for data contained in the BUMF.

The use apparatus that is to use the addition data first verifies a signature of the file-tampering verification data (BUSF) to check the legitimacy of the BUMF. Under the condition that the checking is completed, the user apparatus uses the BUMF to execute conversion of the file names of the addition data, stored on the local storage section, to construct the virtual file system.

However, the number of pieces of the addition data is not necessarily one with respect to content stored on a single disc, and various pieces of addition data are sequentially supplied from the server(s). For example, various types of addition data, such as preview information, a company-A's advertisement information, and a company-B's advertisement information associated with movie content stored on a single disc, may be sequentially supplied to the user apparatus. The user apparatus that receives the addition data performs virtual-file-system update processing that involves update of the BUMF and the file-tampering verification data (BUSF) each time the addition data is obtained. The user apparatus that sequentially obtains the addition data frequently would necessitate frequent performance of such processing. Thus, it is desired to enhance the efficiency of the processing.

### SUMMARY OF THE INVENTION

The present invention has been conceived in view of, for example, the foregoing situation, and it is desirable to provide an information processing apparatus, an information processing system, an information processing method, and a program which generate data and which are capable of performing quick playback processing by simplifying update processing for a virtual file system when content stored on a medium, such as a DVD or Blu-ray Disc®, and addition data, such as data downloaded from a server, are played back in combination.

According to a first embodiment of the present invention, there is provided an information processing apparatus. The information processing apparatus includes a data processing section configured to generate data that is capable of being played back using general playback control information containing clip information defining the number of playback packets. The data processing section generates a data file in which data containing a number of playback packets, the number matching the defined number of playback packets, is contained as playback data associated with the clip information.

The data processing section may perform processing for causing the number of playback packets contained in the playback data associated with the clip information to match the defined number of playback packets, by inserting a null packet.

The clip information contained in the general playback control information may define an I (intra) picture reading start position and the number of read bytes, and the data processing section may generate a data file in which MPEG (moving picture experts group) data having an I picture that is compliant with the defined I-picture reading start position and the defined number of read bytes.

The data processing section may perform processing for causing the number of read bytes for the I picture to match the defined number of read bytes, by performing processing for embedding an arbitrary value in a user data field in the MPEG data.

The data processing apparatus may generate at least one AV (audio visual) stream file that is a data file contained as playback data associated with the clip information, a total playback time of packets in the playback data contained in the generated AV stream matching a playback time defined by a playlist contained in the general playback control information.

A playback start position defined by the clip information may be a position of a first I picture in an AV stream file containing playback data associated with the clip information, and the data processing section may generate an AV stream file containing playback data set so that a first I picture in the AV stream file is a playback start position.

The information processing apparatus may further include a communication section that transmits the data file generated by the data processing section to a user apparatus that performs data playback processing using general playback control information.

According to a second embodiment of the present invention, there is provided an information processing system. The information processing system includes a playback apparatus that executes data playback processing and a server that supplies a data file containing data to be played back to the playback apparatus. The playback apparatus includes a storage section on which the data file supplied from the server and a general playback control information file that is usable as playback control information that is common to different data files are stored, and a data processing section that executes data playback processing by constructing a virtual file system in which data stored on the storage section and data stored on an information recording medium are merged. During modification of a data file to be played back using the virtual file system, the data processing section performs virtual-file-system update processing that involves only modification of the data file without modifying the general playback control information file. The server generates a data file containing data having a structure corresponding to playback-data definition information contained in the general playback control information file and supplies the generated data file to the playback apparatus.

According to a third embodiment of the present invention, there is provided an information processing method executed by an information processing apparatus. The information processing method includes a step of causing a data processing section to generate data that is capable of being played back using general playback control information containing clip information defining the number of playback packets. In the data generating step, a data file in which data containing a number of playback packets, the number matching the defined number of playback packets, is contained as playback data associated with the clip information is generated.

According to a fourth embodiment of the present invention, there is provided a program that causes an information processing apparatus to execute data generation processing. The program includes a step of causing a data processing section to generate data that is capable of being played back using general playback control information containing clip information defining the number of playback packets. In the data generating step, a data file in which data containing a number of playback packets, the number matching the defined number of playback packets, is contained as playback data associated with the clip information is generated.

The program according to the embodiment of the present invention can be supplied to, for example, image processing apparatuses and computer systems that can execute various program codes via communication media and recording media supplied in a computer readable format. Supplying such a program in a computer-readable format can cause the image processing apparatus a computer system to achieve processing according to the program.

Further objects, features, and advantages of the present invention will become apparent from more detailed descriptions based on an embodiment described below according to the present invention and the accompanying drawings. The term “system” herein refers to a logical combination of a plurality of apparatuses and is not limited to a system in which individual apparatuses are included in the same housing.

As described above, according to the configuration of the embodiment of the present invention, addition data supplied to the playback apparatus (user apparatus) that uses the virtual file system (VFS) to perform processing for playing back data stored on the information recording medium and addition data stored on a local storage section can be played back using the general playback control information that is usable for multiple different pieces of addition data. For example, an AV stream file is generated according to the number of playback packets, a playback start position, an I-picture reading start position, and the number of read bytes, which are defined by the clip information in the general playback control information. The use of the file makes it possible to simplify the virtual-file-system update processing that involves update of the file-name conversion table, to speed up the virtual-file-system update involved in modification of addition data, and to reduce the amount of time until the playback start time.

### BRIEF DESCRIPTION OF THE DRAWINGS

FIG. 1 is a diagram illustrating an example of a configuration according to an embodiment of the present invention;

FIG. 2 is a diagram showing an example of data stored on an information recording medium and an example of content playback processing performed by a playback apparatus (user apparatus);

FIG. 3 is a diagram illustrating an example of the format of content stored on the information recording medium;

FIG. 4 is a diagram illustrating an example of a specific structure of a CPS unit key file;

FIG. 5 is a diagram illustrating a virtual file system (VFS) generated by the playback apparatus;

FIG. 6 is a table illustrating an example of a file-name conversion table contained in addition-data search information;

FIG. 7 is a diagram illustrating processing for updating the virtual file system;

FIG. 8 is a diagram illustrating data stored on a local storage section in a playback apparatus according to one embodiment of the present invention and data obtained from a server;

FIG. 9 is a diagram illustrating data stored on the local storage section in the playback apparatus according to the embodiment of the present invention and data obtained from the server; and

FIG. 10 is a diagram illustrating an example of restrictions and a structure of a playlist contained in general playback control information that is usable for multiple pieces of addition data.

### DESCRIPTION OF THE PREFERRED EMBODIMENTS

Details of an information processing apparatus, an information processing system, an information processing method, and a program according to an embodiment of the present invention will be described below with reference to the accompanying drawings. The description will be given in accordance with the following points:

1. Overview of Configuration and Processing according to the Invention;

2. Overview of Content Playback Processing Using Virtual File System (VFS) and Overview of File Name Conversion Table (BUMF); and

3. Configuration of Playback Processing for Addition data Using General Playback Control Information Containing Common Playlist.

[1. Overview of Configuration and Processing According to the Invention]

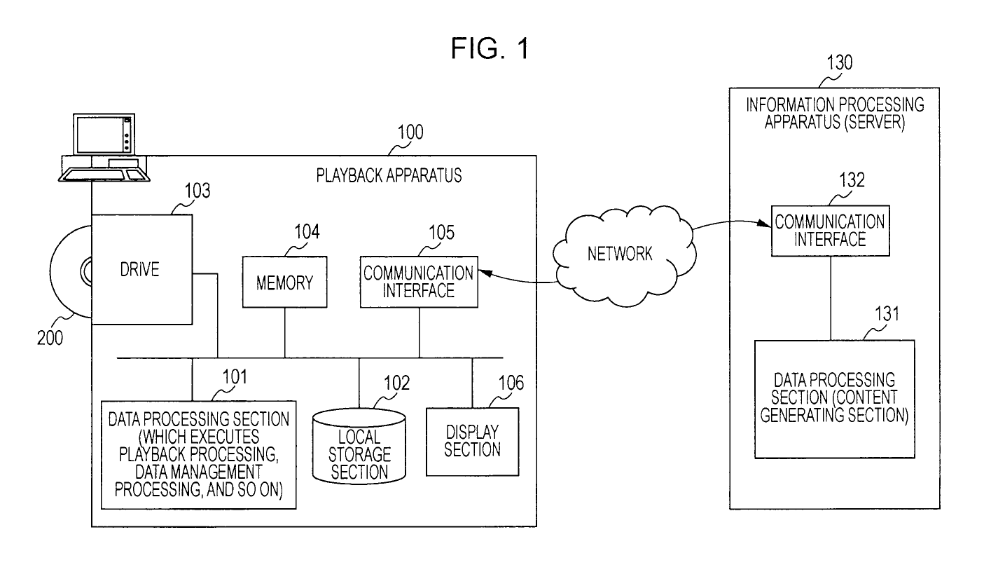

First, a description will be given of an overview of a configuration and processing according to the present invention. FIG. 1 shows an information processing apparatus (a server) 130 and a playback apparatus 100. The information processing apparatus 130 supplies data, and the playback apparatus 100 serves as a user apparatus to receive the supplied data and performs playback processing thereon. The playback apparatus 100 executes playback processing of an information recording medium (a disc) 200, such as a DVD (digital versatile disc) or a Blu-ray Disc®. Examples of the playback apparatus 100 include a personal computer (PC) and a player. The information processing apparatus 130 generates data (addition data) to be supplied to the playback apparatus 100.

This playback apparatus 100 includes:

a data processing section 101 (such as a CPU) having a program execution function for executing content playback processing, addition-data management processing, and so on;

a local storage section 102 that stores, as data associated with content stored on the information recording medium 200, addition data and management information, such as data downloaded from the information processing apparatus 130 and data generated by a user;

a drive 103 that writes/reads data to/from the information recording medium 200;

a memory 104 (implemented by a ROM [read only memory] and a PAM [random access memory]) used for a program execution area, a parameter storage area, and so on;

a communication interface 105 that executes communication over a network; and

a display section 106 that displays content and content information.

The local storage section 102 is implemented by, for example, a hard disk or a flash memory. When the information recording medium 200 has a recordable-data-area structure (e.g., an R-type medium, RE-type medium, or partial ROM), part of the information recording medium 200 may be used as a local storage section.

The playback apparatus 100 reads content, stored on the information recording medium 200, therefrom via the drive 103, and performs playback processing of the content. The processing is performed under the control of the data processing section 101. The information recording medium 200 may be any medium, for example, a ROM disc on which content is pre-stored or a medium (e.g., data writable R-type or RE-type medium) that can record content obtained through processing, such as a user performing downloading from the information processing apparatus 130.

The playback apparatus 100 obtains, from the information storage apparatus 130, addition data that is usable in conjunction with playback of the content stored on the information recording medium 200, and stores the addition data on the local storage section 102, which may be implemented by a hard disk, a flash memory, or the like. For example, the term “addition data” obtained from the information processing apparatus 130 refers to, for example, when the content stored on the information recording medium 200 is movie content, caption data or dubbed data as well as data of various moving images, still images, and so on (such as service data, previews, and advertisements) associated with the content stored on the information recording medium 200. When the content stored on the information recording medium 200 is a game program or the like, addition data, such as score information and progress information obtained through play of a game, is stored on the local storage section 102.

The addition data stored on the local storage section 102 is data that has been obtained or generated in association with, for example, any part of the content stored on the information recording medium 200. During playback processing of the content stored on the information recording medium 200, the addition data stored on the local storage section 102 and selected by the user can be played back in conjunction with each other. To perform the playback processing, for example, a virtual package in which the content stored on the information recording medium 200 and the content stored on the local storage section 102 (such as a hard disk) are merged is set to construct a virtual file system (VFS). The virtual-file-system-based playback processing allows for playback as if the playback processing were performed from a single medium. Details of the virtual-file-based-based playback processing are described below.

When the addition data is recorded, the data processing section 101 generates or updates management information and description information regarding the addition data and stores the resulting information on the local storage section 102, as appropriate. The data processing section 101 records the addition data, the management information, and the description information in an addition-data directory set on the local storage section 102.

The data processing section 101 manages a group of data, used for the virtual file system stored on the local storage section 102, for each management unit also called a binding unit (BU). The management unit (BU) is set as a unit including the addition data, which is subsequently generated or obtained in association with the content stored on the information recording medium 200. Examples of the addition data include content downloaded from the server or data generated by the user.

When the content stored on the information recording medium 200 and the addition data stored on the local storage section 102 are played back in conjunction with each other, the data processing section 101 constructs the virtual file system, as described above, to perform playback processing. In this case, the data processing section 101 performs processing for converting file names of the addition data stored on the local storage section 102. For the conversion processing, a table that is referred to as a file-name conversion table (a “binding unit manifest file (BUMF)”) is used. In the binding unit manifest file (BUMF), the addition data management information is recorded for each management unit (the binding unit (BU)).

The information processing apparatus 130 shown in FIG. 1 supplies data (addition data) to the playback apparatus 100. The information processing apparatus 130 has a data processing section 131 and a communication interface section 132. The data processing section 131 generates data (addition data) to be played back by the playback apparatus 100, and the communication interface section 132 serves as a communication section for transmitting the data, generated by the data processing section 131, to the playback apparatus 100.

The data processing section 131 in the information processing apparatus 130 uses the virtual file system, constructed by the playback apparatus 100, to generate addition data that can be played back. The generated addition data is supplied to the playback apparatus 100 via the communication interface 132.

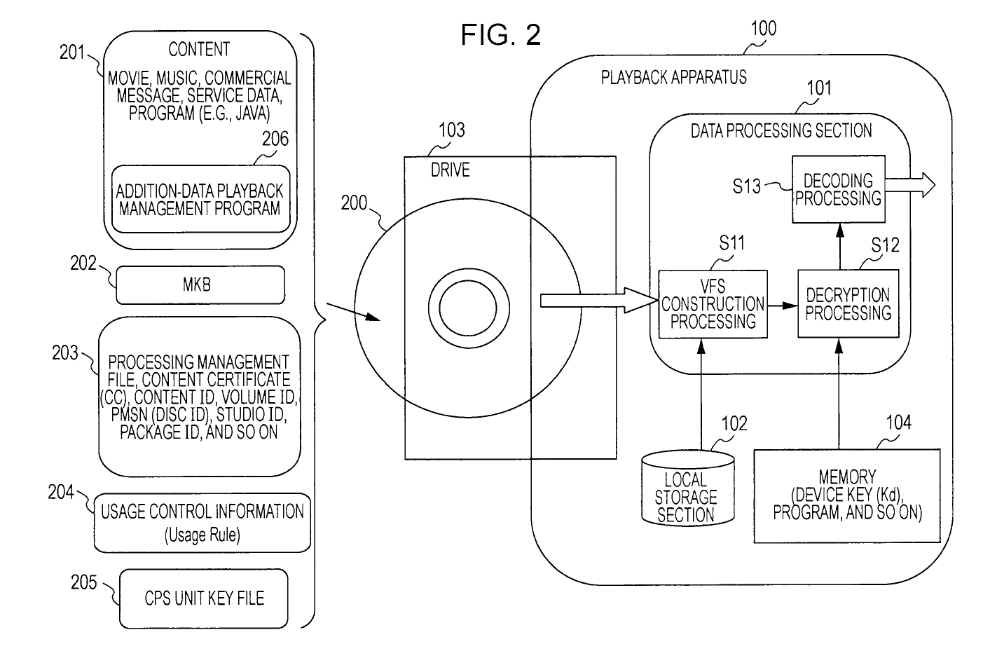

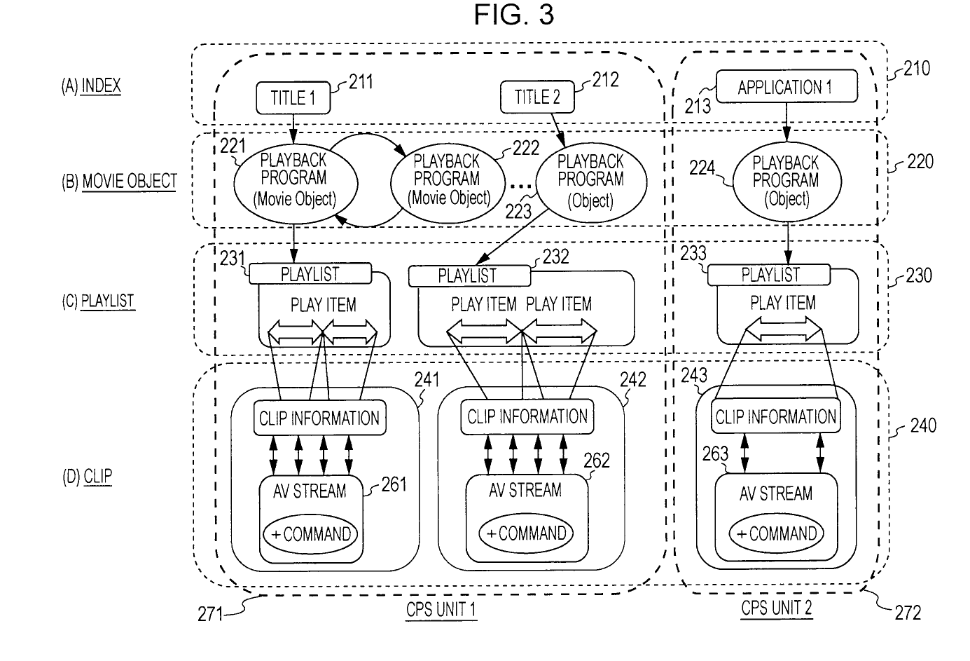

Next, an example of data stored on the information recording medium 200 and an example of content playback processing performed by the playback apparatus 100 will be described with reference to FIGS. 2 and 3. FIG. 2 is a diagram showing an example of data stored on the information recording medium 200 and an example of content playback processing performed by the playback apparatus 100. In this case, an example of information stored on a ROM disc, which is a content-storing disc, is described. The playback apparatus 100 may be any playback apparatus, such as a PC or a disc player. The drive 103 in the playback apparatus 100 executes processing for reading data from the information recording medium 200.

The ROM disc which is the information recording medium 200 is, for example, a Blu-ray Disc® or a DVD. The ROM disc is a legitimate-content storing medium that is manufactured at a disc-manufacturing plant under the permission of a legitimate-content right holder.

As shown in FIG. 2, the information processing medium 200 stores:

content 201;

a media key block (MKB) 202 serving as a cryptographic key block generated based on a tree-structure key distribution system, which is one type of a broadcast encryption system;

a processing management file 203 including a content certificate (CC) for certifying legitimacy of content and so on stored on the information recording medium 200, a content ID serving as a content identifier, a volume ID set as identification information for each information recording medium or a predetermined number of information recording media, a PMSN (prerecorded media serial number) corresponding to a media ID serving as a disc-unique identification information, and so on;

usage control information (a usage rule) 204 including, for example, copy control information (CCI) serving as copy/playback control information for the content; and

a CPS unit key file 205 that stores CPS unit keys which are cryptographic keys set for respective content management units (CPS units) serving as content usage management units.

In this example, the content 201 includes an addition-data playback management program 206 serving as program information used for processing for downloading content from the information processing apparatus 130 (described below). The addition-data playback management program includes, for example, a Java® application and is also called a “BD-J application”. A description will now be given of an overview of information stored on the information recording medium 200.

(1) Content 201 The information recording medium 200 stores various types of content 201. Examples of the content 201 include an AV (audio visual) stream of moving-image content, such as HD (high-definition) movie content (which contains high-definition moving image data), game programs, image files, audio data, text data, and Java® application programs.

The content 201 further includes sub content, such as Java® application programs, game programs, image files, audio data, and text data.

Types of content for both main content and sub-content include content, such as music data, image data of moving images, still images, and so on, game programs, and web content. These pieces of content include various types of information, such as content information usable only with data obtained from the information recording medium 200 and content information usable together with data obtained from the information recording medium 200 and data supplied from the server 130 connected to the network.

### (2) MKB

The media key block (MKB) 202 is a cryptographic key block generated based on a tree-structure key distribution system, which is known as one type of a broadcast encryption system. The MKB 202 is a key information block that enables a media key (Km) used for decrypting content to be obtained by only processing (decryption) based on a device key (Kd) stored on an information processing apparatus of the user having a valid license. The MKB 202 employs an information distribution system that complies with the so-called “hierarchical tree structure”. The MKB 202 enables only a user device (the information processing apparatus) having a valid license to acquire the media key (Km) and disables an invalidated (revoked) user device to acquire the media key (Km).

### (3) Processing Management File

For example, the processing management file 203 contains:

content certificate (CC) serving as a certificate for certifying the legitimacy of the content stored on the information recording medium 200;

a content ID serving as an identifier of the content stored on the information recording medium 200;

a volume ID set as identification information for each information recording medium or for a predetermined number of information recording media; and

a PMSN (prerecorded media serial number) corresponding to the media ID serving as disc-unique identification information.

The processing management file further contains data for a disc ID serving as identification information of the information recording medium 200, a studio ID serving as an identifier of the editing studio of the content stored on the information recording medium 200, a package ID serving as a package identifier which is a manufacturing unit of the information recording medium 200. The package ID may also be called a “disc ID”.

### (4) Usage Control Information (Usage Rule)

The usage control information (usage rule) 204 includes, for example, copy/playback control information (CCI). More specifically, the usage control information 204 includes copy restriction information and playback restriction information for usage control corresponding to the encrypted content 201 stored on the information recording medium 200 or content subsequently obtained from the server 130. The copy/playback control information (CCI) can be set in various manners, for example, can be set as information for each CPS unit set as a content management unit or may be set as information for multiple CPS units.

### (5) CPS Unit Key File

As described above, the encrypted content 201 stored on the information recording medium 200 is divided into CPS units set as content management units, and the divided CPS units are encrypted using respective cryptographic keys. The playback apparatus for executing playback processing identifies a CPS unit to which content to be played back belongs and performs decoding processing using a CPS unit key serving as a cryptographic key corresponding to the determined CPS unit. Data used for obtaining the CPS unit key is contained in the CPS unit key file.

FIG. 2 shows details of the data stored on the information recording medium 200 and an overview of processing of the playback apparatus 100 for playing back the content stored on the information recording medium 200 and content stored on the local storage section 102 (e.g., content subsequently obtained from the server or the like) in conjunction with each other. As described above, the playback apparatus 100 has the drive 103 for executing processing for reading the data stored on the information recording medium 200.

First, in step S11, the data processing section 101 in the playback apparatus 100 performs processing for constructing a virtual file system (VFS). That is, the data processing section 101 sets a virtual package in which the content stored on the information recording medium 200 and the content stored on the local storage section 102 (such as a hard disk) are merged and constructs a virtual file system used for playback of the virtual package. The virtual-file-system-based playback processing allows for playback as if the playback processing were performed from a single medium. Thereafter, in steps S12 and S13, the data processing section 101 executes content decryption processing and content decoding processing to execute content playback. The decoding processing is performed based on, for example, an MPEG (moving picture experts group) standard.

The memory 104 includes a ROM and a RAM used for a program execution area, a data storage area, and so on and stores the device key (Kd) used for content decryption processing, programs for executing various types of processing, and so on. The playback apparatus 100 generates a key used for decrypting content on the basis of the data stored in the memory 104 and the data read from the information recording medium 200, and executes processing for decrypting encrypted content to be played back.

Next, an example of the format of the content stored on the information recording medium 200 will be described with reference to FIG. 3. With respect to at least part of the content stored on the information recording medium 200, units are assigned respective keys, are subjected to encryption processing, and are stored in order to achieve usage control that is different for each unit. That is, the content is divided into content management units (CPS units), which are subjected to independent encryption processing and are managed for individual usage.

During use of the content, for example, during playback of encrypted content, it is necessary for a CPS unit key assigned to each unit to be obtained, and other keys, key generation information, and so on are also used to execute data processing playback based on a predetermined decryption processing sequence to thereby perform playback. Settings of the content management units (CPS units) will now be described with reference to FIG. 3.

As shown in FIG. 3, the content has a hierarchical structure including (A) index 210, (B) movie object 220, (C) playlist 230, and (D) clip 240. When an index such as a title accessed by a playback application is specified, a playback program associated with the title or the like is specified and a playlist that defines a content playback sequence and so on is selected in accordance with program information of the specified playback program.

The playlist includes play items, which are playback-data-specifying information. Clip information indicates a playback segment defined by a play item contained in the playlist. Based on the clip information, an AV stream, which is main data of the content is selectively read and is played back. A large number of playlists may be provided and playlist IDs are associated therewith as identification information, and also a large number of play items may be provided and play item IDs are associated therewith as identification information.

The format shown in FIG. 3 is an encrypted-content format that complies with an AACS (advanced access content system) standard. Not all content 201 stored on the information recording medium 200 necessarily have to be data that complies with the format. Other than the encrypted data recorded according to the format, various other types of content can be recorded to the information recording medium 200. Examples of the content include commercial content, service content, and Java® program content. The data of the content may be recorded to the information recording medium 200 as unencrypted content, and such content can also be played back using the playlist.

That is, although the playlists shown in FIG. 3 are examples of playlists in which only AV streams containing encrypted data are specified for playback, for example, playlists for playback of AV streams that comply with the AACS standard and content containing unencrypted data can also be set. When the user plays back the content, he or she designates a title to perform the playback. As a result of the user's title designation, a playback program is selected, a playlist is selected through the selected playback program, and one piece or multiple pieces of playback content are sequentially selected based on the selected playlist and are played back.

FIG. 3 shows two CPS units in the encrypted content contained in the content 201 stored on the information recording medium 200. The CPS units constitute part of the content stored on the information recording medium 200. Each of a CPS unit 1 271 and a CPS unit 2 272 is set as a unit containing at least one title or application serving as an index, at least one movie object serving as a playback program file, at least one playlist, and at least one clip containing an AV stream file serving as content main data.

The content management unit (CPS unit) 1 271 contains a title 1 211 and a title 2 212, playback programs 221, 222, and 223, playlists 231 and 232, and clips 241 and 242. The two clips 241 and 242 contain AV stream data files 261 and 262, which are content main data. At least the AV stream data files 261 and 262 are encrypted and are, in principle, set as data encrypted with a CPS unit key Ku1, which is a cryptographic key set in association with the content management unit (CPS unit) 1 271.

The content management unit (CPS unit) 2 272 includes an application 1 213 serving as an index, a playback program 224, a playlist 233, and a clip 243. An AV stream data file 263, which is content main data contained in the clip 243, is encrypted with a CPS unit key Ku2, which is a cryptographic key set in association with the content management unit (CPS unit) 2 272.

For example, in order for the user to execute playback processing of an application file or content associated with the content management unit 1 271, he or she has to obtain the unit key Ku1, which is a cryptographic key set in association with the content management unit (CPS unit) 1 271, to execute decryption processing. In order for the user to execute playback processing of an application file or content associated with the content management unit 2 272, he or she has to obtain the unit key Ku2, which is a cryptographic key set in association with the content management unit (CPS unit) 2 272, to execute decryption processing.

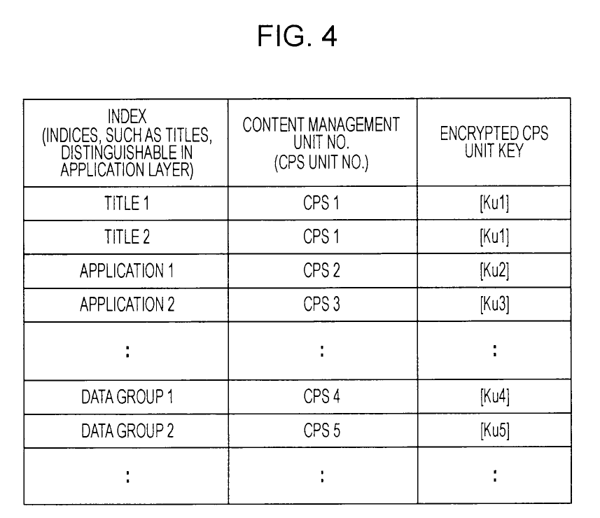

FIG. 4 is a table showing a specific example of the structure of the CPS unit key file. As shown in FIG. 4, the CPS unit key file is divided into areas for respective pieces of index information, such as titles, and has a data structure in which content management unit numbers (CPS unit numbers) corresponding respective indices and encrypted CPS unit keys [Kun] are associated with each other.

[2. Overview of Content Playback Processing Using Virtual File System (VFS) and Overview of File Name Conversion Table (BUMF)]

As described above, when the content stored on the information recording medium (disc) 200 and the addition data stored on the local storage section 102 are played back in conjunction with each other, the data processing section 101 in the playback apparatus 100 constructs a virtual file system (VFS) to perform content playback processing. In this case, the data processing section 101 performs processing for converting the file names of the addition data stored on the local storage section 102. For the conversion processing, a file-name conversion table (a binding unit manifest file (BUMF)) is used. Now, a description will be given of an overview of the content playback processing using the virtual file system and an overview of the file-name conversion table (BUMF).

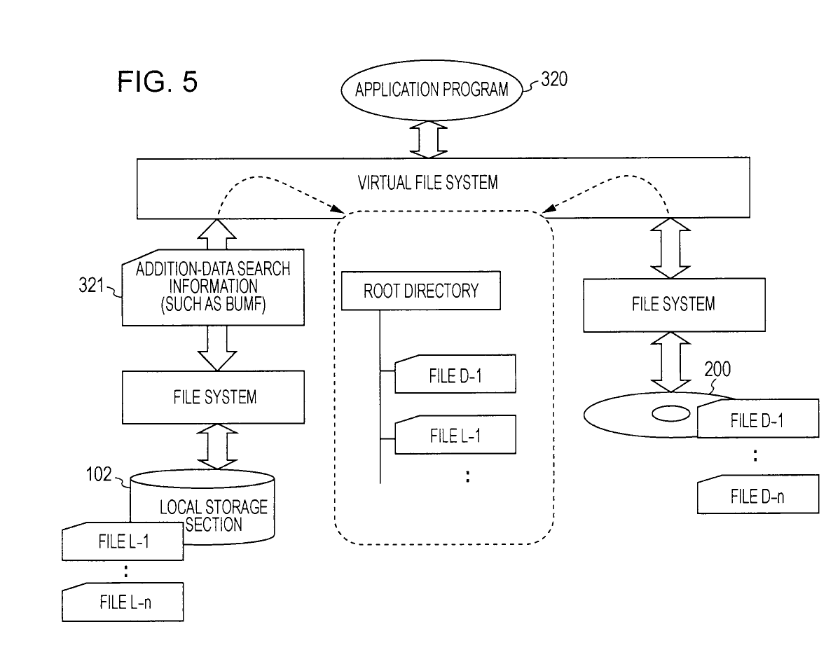

The virtual file system that is set when the content stored on the information recording medium 200 and the addition data stored on the local storage section 102 (such a hard disk) are played back in conjunction with each other will now be described with reference to FIG. 5. For example, it is assumed that the content stored on the information recording medium 200 is French-language movie content and the addition data stored on the local storage section 102 is Japanese-language subtitle data associated with the movie content. In this case, playback of both of the movie content and the subtitle data in conjunction with each other allows playback of the movie with the Japanese-language subtitle.

For such combined content playback, the playback apparatus 100 virtually combines a directory and files containing the addition-data management file stored on the local storage section 102 with a directory and files stored on the information recording medium 200. That is, the playback apparatus 100 sets a virtual file system. In the virtual-file-system setting processing, a data file on the information recording medium 200 and a corresponding addition-data file on the local storage section 102 are set as a file in one virtual directory.

An application program 320 shown in FIG. 5 is either an application program for executing playback processing and so on for the playback apparatus 100 (e.g., addition-data playback management program (a BD-J application)) or a program that is loaded into the playback apparatus 100 and that is unique to the playback apparatus 100. The application program 320 performs operation on files recorded on the information recording medium 200 and files recorded on the local storage section 102 via the virtual file system. The application program 320 uses addition-data search information 321 via the virtual file system to obtain a specific addition data file. The addition-data search information 321 is search information for the files recorded on the local storage section 102.

The virtual file system serves to conceal a difference in recording medium (a file system) with respect to the application program 320. Thus, without realizing a difference in recording medium on which files are recorded, the application program 320 can perform operation on files recorded on each recording medium by using the same API.

For example, the virtual file system is generated by merging, when the information recording medium 200 is loaded into the playback apparatus 100 or when the application program 320 is executed, a file system on the information recording medium 200 and a file system on the local storage section 102, and the generated virtual file system is stored in the memory 104 in the playback apparatus 100.

When the user wishes to perform processing, such as adding new content to the constructed virtual file system, it is generally necessary to renew the virtual file system.

As described above, the playback apparatus 100 sets the virtual file system used when the content stored on the information recording medium 200 and the addition data stored on the local storage section 102 are played back in conjunction with each other.

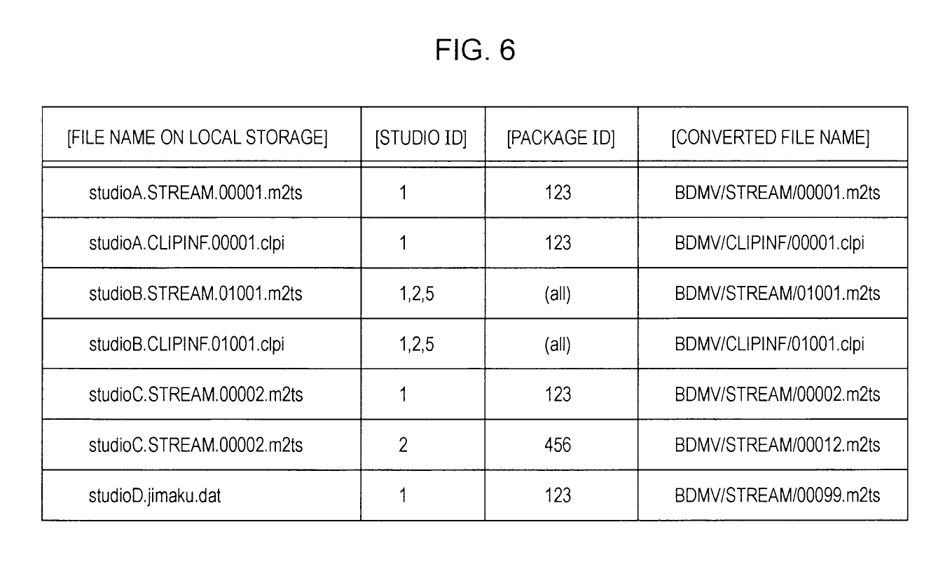

The processing for setting the virtual file system involves processing for converting the file names of the addition data stored on the local storage section 102. For the file-name conversion processing, the file-name conversion table (BUMF) is used. The structure of the file-name conversation table (BUMF) will now be described with reference to FIG. 6.

The playback apparatus 100 holds, on the local storage section 102, the file-name conversion table (BUMF) together with addition-data files obtained from the server 130 or the like. During the virtual file system generation processing, the playback apparatus 100 refers to the file-name conversion table (BUMF) to convert file names on the local storage section 102 into file names on the virtual file system and sets the converted file names on the virtual file system.

The file-name conversion table (BUMF) shown in FIG. 6 has a structure in which entries in “File Name on Local Storage Section”, “Studio ID”, “Package ID”, and “Converted File Name ” are associated with each other. That is, the file-name conversion table has information for converting the file names stored on the local storage section 102 into virtual-file-system file names.

The [File Name on Local Storage] indicates actual file names used during recording to the local storage section 102 in which the addition data is stored. For example, studio names are added to the file names so that no duplication occurs.

The file-name conversion processing is determined depending on, for example, a studio ID and a package ID associated with playback content. When the playback processing is executed, processing for biding the data on the information recording medium (disc) 200 and the addition data is performed. All addition data to be used are associated with studio IDs and package IDs. The playback apparatus 100, which performs content playback processing, obtains a studio ID and a package ID of content to be played back; obtains a converted file name by using the file-name conversion table, on the basis of the obtained IDs; and sets the obtained file name as a file name on the virtual file system.

For example, when the file name on the local storage section 102 is studioA.STREAM.00001.m2ts, the studio ID of playback content is 1, and the package ID is 1, 2, or 3, the converted file name is BDMV/STREAM/00001.m2ts. This converted file name “BDMV/STREAM/00001.m2ts can be used by the playback application.

In this manner, the use of the file-name conversion table (BUMF) to execute file-name conversion allows arbitrary file names to be set for directory on the local storage section 102 and also allows files with arbitrary unduplicated names to be set.

The second and third entries from the bottom of the file-name conversion table (BUMF) shown in FIG. 6 have the same [File Name on Local Storage], which is studioC.STREAM.00002.m2ts. The converted file name for studio ID=1 and package ID=1, 2, or 3 is BDMV/STREAM/00002.m2ts and the converted file name for studio ID=2 and package ID=4, 5, or 6 is BDMV/STREAM/00012.m2ts. Thus, the file-name conversion table is configured to convert file names into different file names from each other depending on the values of a studio ID and a package ID. In this manner, the use of the file-name conversion table to perform file-name conversion processing makes it possible to set different files used by, for example, different playback applications.

In order to stringently perform manage usage of the addition data, a file-tampering verification data (or a binding unit signature file (BUSF)) is stored on the local storage section 102 in the playback apparatus 100.

The playback apparatus (the user apparatus) for using the addition data verifies a signature in the file-tampering verification data (BUSF) to check the legitimacy of the binding unit manifest file (BUMF). Under the condition that the checking is completed, the playback apparatus uses the binding unit manifest file (BUMF) to execute conversion of the file names of the addition data, stored on the local storage section 102, to construct the virtual file system.

[3. Configuration of Playback Processing for Addition Data Using General Playback Control Information Including Common Playlist]

Next, a description will be given of an embodiment in which general playback control information including a common playlist is used to make it possible to perform playback processing for various different types of addition data.

As described above in [2. Overview of Content Playback Processing Using VFS and Overview of File Name Conversion Table (BUMF)], the virtual file system is set when the content stored on the information recording medium 200 and the addition data stored on the local storage section 102 are played back in conjunction with each other. During the processing, processing for converting the file names of the addition data stored on the local storage section 102 is performed. For the conversion processing, the file-name conversion table (BUMF) described above with reference to FIG. 6 is used.

In the virtual-file-system setting processing, a data file on the information recording medium 200 and an addition-data file on the local storage section 102 are set as a file in one virtual directory.

When the information recording medium 200 is loaded into the playback apparatus 100 or when the application program 320 is executed, the virtual file system is generated by merging the file system of the information recording medium 200 with the file system of the local storage section 102. As described above, in general, each time a directory or file recorded on the local storage section 102 is modified upon writing of a file or the like, it is typically necessary to update the virtual file system.

However, there is a problem in that it takes time to perform processing for updating the virtual file system. As described above with reference to FIG. 3, the content has a hierarchical structure including (A) index 210, (B) movie object 220, (C) playlist 230, and (D) clip 240.

In typical traditional processing, when addition data is to be obtained from a server, information files, such as clip information (clip information files), play items, a playlist, and so on used for playback of AV stream data are also obtained in conjunction with main data to be played back, such as an AV stream for movie preview content, advertisement content, and so on.

Thus, for the playback apparatus of the user who has obtained the addition data, it is necessary to update the file-name conversion table (BUMF) corresponding to the received files and to update the virtual file system. Only after the virtual-file-system update is competed, newly obtained addition data can be played back using the VFS.

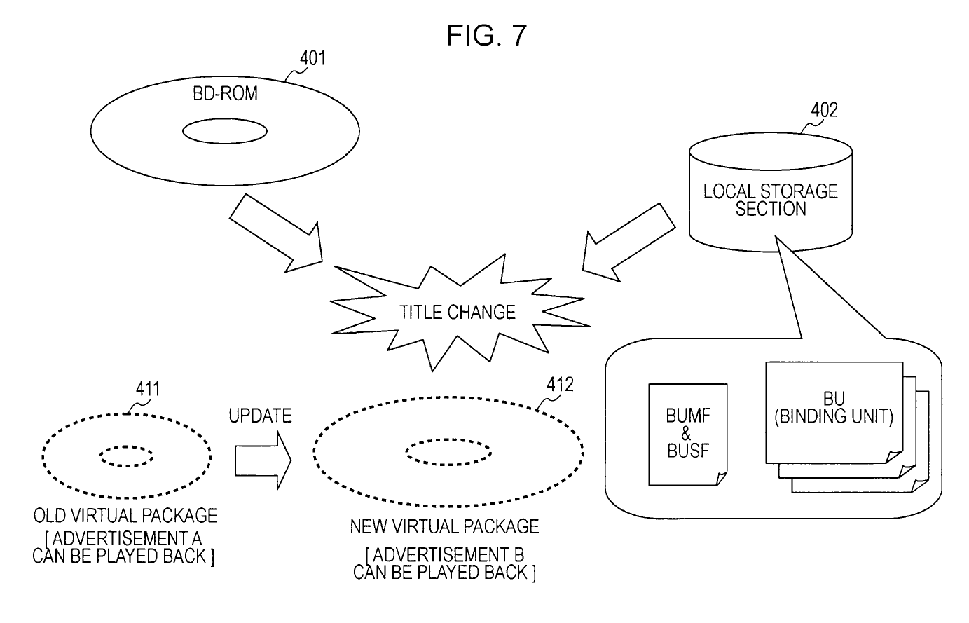

An example of the VFS update will now be described with reference to FIG. 7. For example, it is now assumed that the playback apparatus for performing content playback has obtained addition data “advertisement A” associated with one ROM disc 401 on which movie content is stored and has stored the obtained addition data “advertisement A” on a local storage section 402.

It is also assumed that the virtual package used for playback of the advertisement A is an old virtual package 411 shown in FIG. 7. A virtual package corresponds to a virtual-disc package containing content, control data, and so on used for data playback processing that uses the virtual file system.

When the old virtual package 411 is used, playback of the movie content stored on the ROM disc 401 and the addition data “advertisement A” stored on the local storage section 402 can be executed as processing as if it were performed from a single medium. For example, the playback processing can be performed through designation of a title set in the old virtual package 411.

It is assumed that, thereafter, the playback apparatus has obtained new addition data “advertisement B” from the server and has stored the obtained addition data “advertisement B” on the local storage section 402. The new addition data “advertisement B” may not be played back using the old virtual package 411. Only the advertisement A can be played back through designation of a title set for the virtual package 411. Thus, a new virtual package 412 is set in order to play back the newly obtained “advertisement B”.

That is, the playback apparatus performs processing for updating the virtual file system. The virtual file system update processing involves multiple types of processing, such as update of the file-name conversion table (BUMF). As the number of files obtained from the information processing apparatus (server) increases, a larger amount of time is taken for the update processing. As described above, in the related art, the user apparatus obtains, from the server, a large number of files of clip information (the clip information file), a playlist, play items, and so on in addition to AV streams (which are main data for advertisement content and so on), and thus generally performance of processing corresponding to all the files is necessary.

In an example of processing described below, data supplied from the information processing apparatus (server) to the playback apparatus (the user apparatus) are only AV streams, which are main data of advertisement content and so on. Files already stored on the playback apparatus are used as playback control information files of playlists, play items, clip information (clip information files), and so on. Thus, the amount of addition data that is to be newly received is reduced, so that the virtual-file-system update processing is simplified. The simplified virtual-file-system update processing allows the playback apparatus (the user apparatus) to quickly play back addition data newly received from the server.

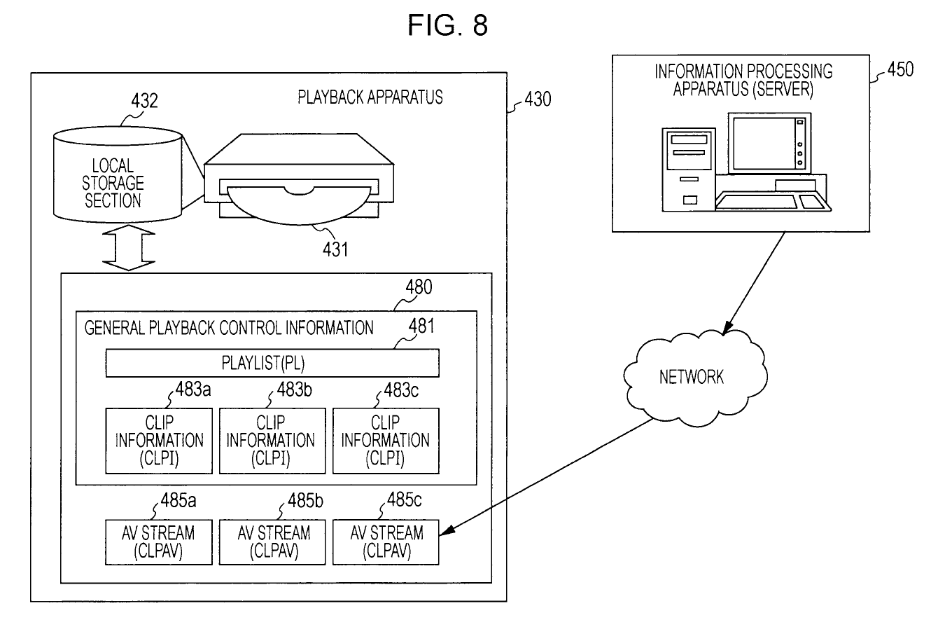

That is, in an example shown in FIG. 8, setting is performed so as to allow the playlist, play items, and clip information used in the old virtual package 411 to be also used in the new virtual package 412.

In the present embodiment, data obtained from the server as the addition data are only AV stream data, and the playlist, play items, and clip information, which are playback control information used for playback of the AV streams, are set as general playback control information that is usable for various types of addition data (AV streams). That is, the data processing section in the information processing apparatus (server) uses the general playback control information to generate data to be played back and supplies the generated data to the playback apparatus via the communication section.

The structure of the general playback control information and the structure of the addition data will now be described with reference to FIG. 8. FIG. 8 shows a playback apparatus 430 and an information processing apparatus (server) 450. The playback apparatus 430 executes playback processing of an information recording medium 431, such as a DVD or a Blu-ray Disc®. The information processing apparatus 450 supplies addition data. That is, the information processing apparatus 450 supplies various types of data of moving images, still images, and so on (such as service data, previews, and advertisements) associated with content stored on, for example, the information recording medium 431 to the playback apparatus 430 through a network.

The playback apparatus 430 stores the data, obtained from the information processing apparatus 450, on a local storage section 432. The playback apparatus 430 constructs a virtual package containing the addition data stored on the local storage section 432 and the content stored on the information recording medium 431 and performs playback processing using the virtual file system.

The local storage section 432 stores general playback control information 480 set to be usable for different pieces of addition data. The arrangement may be such that the general playback control information 480 is stored on the information recording medium 431 together with content (such as movie content) is read by the playback apparatus 430, and is then stored on the local storage section 432. Alternatively, the arrangement may be such that the general playback control information 480 is supplied from the information processing apparatus 450.

The addition data supplied from the information processing apparatus 450 to the playback apparatus 430 in which the general playback control information 480 is stored on the local storage section 432 contains only AV streams 485. No playlist, play item, and clip information are supplied to the playback apparatus 430.

The AV streams 485, which are the addition data supplied from the information processing apparatus 450, are played back using the general playback control information. The general playback control information 480 contains a playlist (PL) 481 and clip information 483. The playlist 481 contains play items.

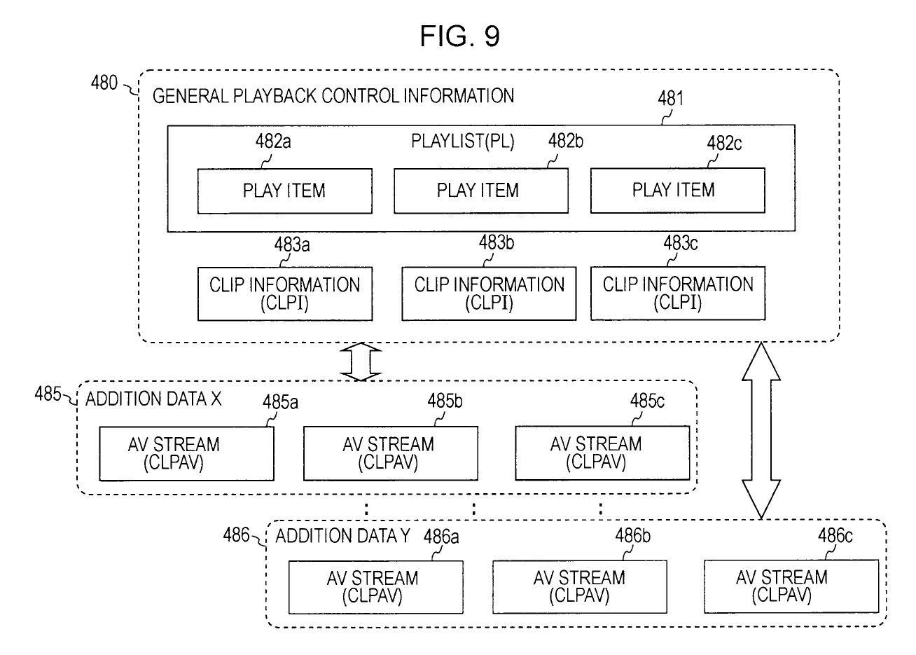

The structure of the data stored on the local storage section 432 will now be described with reference to FIG. 9. As shown in FIG. 9, the local storage section 432 stores the general playback control information 480 that is usable for playback of various AV streams, which are different pieces of addition data.

In addition, the local storage section 432 stores addition data X 485 and addition data Y 486 that contain only AV stream files obtained from the information processing apparatus 450 at various timings. Although only two units of addition data X 485 (including AV streams 485a to 485c) and addition data Y 486 (including AV streams 486a to 486c) are shown, the local storage section 432 can store various other data.

The addition data obtained from the information processing apparatus 450 are AV streams that contain main content (of advertisements, previews, and so on) to be played back. The AV streams can be played back using the general playback control information 480. The same general playback control information 480 is used for both the AV streams 485a to 485c, which constitute the addition data X 485, and the AV streams 486a to 486c, which constitute the addition data Y 486.

The general playback control information 480 contains a playlist 481 having play items 482a to 482c and clip information (CLPI) 483a to 483c. As described above with reference to FIG. 3, the playlist has play items that are playback-data-specifying information. Based on the clip information that indicates a playback segment defined by the play item, an AV stream that provides content main data is selectively read and is subjected to playback processing.

Only one playlist 481 is shown in FIG. 9. The playlist 481 is used for playback of the addition data. In addition to the playlist 481, the local storage section 432 stores, for example, playlists and so on that are used for playback of movie content stored on the information recording medium 431 or the like. A playlist is selected based on a title specified by the user and processing for the playlist is started. In this configuration, when the addition data is to be played back, for example, the illustrated playlist 481 is selected through designation of a title that is set to be common to the addition data and the illustrated addition data X and/or Y is played back.

When the addition data X 485 is an old advertisement pre-obtained from the server and the addition data Y 486 is a new advertisement obtained from the server, the addition data contained in a virtual package used in the virtual file system, the addition data being the addition data X in the old virtual package, is replaced with the addition data Y in the new virtual package. Processing for the AV streams is analogous to the virtual-package update processing described above with reference to FIG. 7. In the present embodiment, the general playback control information 480 that is common to multiple pieces of addition data is used for the playlist, play items, and clip information. That is, for both the old virtual package and the new virtual package, the same general playback control information 480 is used.

That is, the playback apparatus has a configuration as follows.

The local storage section stores data files (AV stream files) containing playback data and a general playback control information file that is usable for the different data files (AV stream files).

The data processing section in the playback apparatus constructs a virtual file system in which the data stored on the local storage section and the data stored on the information recording medium are merged and executes data playback processing. In addition, during modification of a data file to be played back using the virtual file system, the data processing section executes virtual-file-system update processing that involves modification of only the data file without modifying the general playback control information file.

The data processing section in the playback apparatus uses the file-name conversion table (BUMF described above with reference to FIG. 6), which contains the file-name conversion information, to convert the names of files stored on the local storage section into virtual-file-system file names and constructs a virtual file system containing the data stored on the information recording medium and the data stored on the local storage section. However, the data processing section performs the virtual-file-system update processing by modifying conversion information in only the data files without modifying conversion information in the general playback control information file registered in the file-name conversion table.

The general playback control information contains playlist files that define playback time of data files, clip information files that define playback segments, and so on. The common playlist and clip information file set as the general playback control information are used to perform playback processing of different data files.

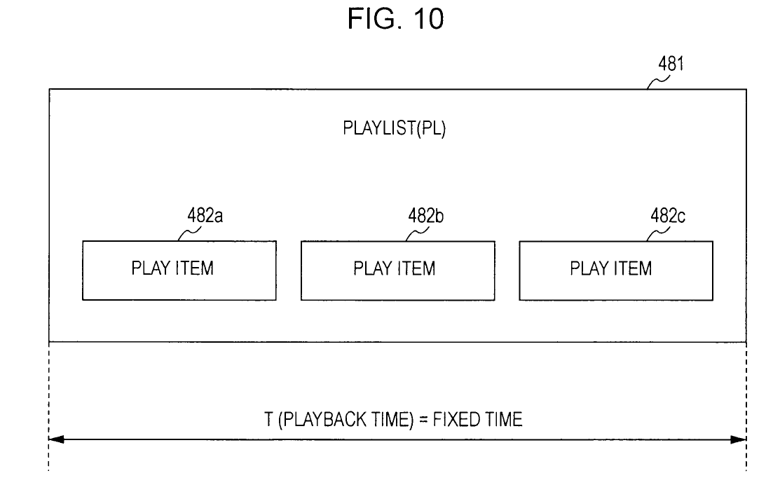

In order to perform processing using the common playlist, play items, and clip information for various AV streams, the data of the playlist, play items, and clip information have a structure according to certain conditions. The conditions will now be described with reference to FIG. 10.

First, conditions for the playlist and play items contained in the general playback control information 480 that is usable for different AV streams will be described with reference to FIG. 10.

As shown in FIG. 10, the playlist 481 contained in the general playback control information 480 has play items 482a to 482c, which are playback-data-specifying information. Each of the play items 482a to 482c is associated with clip information having playback segment information.

The playlist in the general playback control information set for different AV streams is set to have a constant length. That is, as shown in FIG. 10, the playback time “T” for the playlist is set to have a fixed value.

As described above, the playlist has play items. The play items are associated with clip information. The clip information has playback segment information for AV streams. The AV stream is selectively read based on the clip information and is subjected to playback processing. The playlist has data that defines the playback time of an AV stream selected based on the playlist.

The playlist in the general playback control information is set to have a predefined fixed playback length, i.e., a fixed playback time (T), in order to allow playback of various AV streams, which are addition data supplied from the server or the like. The playlist having the fixed playback length is also set for AV streams generated by the server. The total number of packets in an AV stream, the total number being defined by the clip information file, is also fixed in order to allow reuse of the clip information.

The relationship between the file size of an AV stream that is addition data downloaded from the information processing apparatus to the playback apparatus and the play item length (the playback time of AV stream content to be played back for one play item) is defined by:

File Size=Σ(ES rate)×1.5×Play Item Length where ES rate indicates an elementary-stream bitrate.

Time (DL Time) taken for downloading is defined by:

DL Time=(File Size)/(Download Speed).

Next, a description will be given of conditions for the clip information (clip information files) 483 included in the general playback control information 480 (shown in FIG. 9) that is usable for different AV streams.

In order to allow playback of various AV streams, which are addition data supplied from the information processing apparatus (server) 130, the clip information contained in the general playback control information 480 has restrictions as follows.

The clip information has playback segment information defined by play items contained in the playlist. The clip information has information for converting time information indicating playback positions defined for respective play items into packet numbers to identify AV-stream playback positions.

That is, the clip information has information, such as a playback-start-position pocket of packets constituting an AV stream and the number of packets for a playback segment. Specifically, the clip information has a packet number indicating a playback start position in an AV stream file, information of the number of packets of an AV stream file to be played back, and information of the number of packets corresponding to an I-picture (intra-picture) size. The information contained in the clip information set in the general playback control information 480 is set so as to be usable for various different AV streams.

The clip information 483a to 483c in the general playback control information 480 are set to have position information of a first I picture in each AV stream as the playback start position information of the AV streams 485a to 485c in order to allow playback of various AV streams. On the basis of the clip information having the common playback-start position information, an AV stream that is addition data supplied from the server is played back starting at the position of the first I picture in the AV stream.

Each of the AV streams 485a to 485c containing MPEG data has I (intra) pictures, P (predictive) pictures, and B (bidirectionally predictive) pictures. The clip information in the general playback control information 480 is set so that the first I picture in the MPEG data contained in each AV stream is recorded as the playback start time.

Next, a description will be given of a restriction of an AV stream that is addition data supplied from the information processing apparatus (server). The data processing section in the information processing apparatus (server) uses the general playback control information 480 to generate data to be played back and supplies the generated data to the playback apparatus via the communication section. The AV stream that is addition data supplied from the server is played back using the general playback control information 480 described above with reference to FIGS. 9 and 10, and thus a configuration that satisfies a predetermined condition is employed. This restriction will now be described.

The data processing section in the information processing apparatus (server) generates an AV stream (CLPAV) file as a data file to be provided to the playback apparatus. The number of packets in each of the AV stream (CLPAV) files is set to be equal to the number of packets which is registered in the corresponding clip information file.

For example, in the example shown in FIG. 9, it is assumed that the number of packets in each of the AV streams associated with the respective clip information 483a to 483c set in the general playback control information 480 is recorded as N. In this case, the data processing section in the information processing apparatus (server) sets the number of packets in each of the AV streams 485a to 485c, which are addition data, to the number of playback packets which is equal to the number (N) of playback packets which is recorded in the clip information.

Depending on the content, the number of pieces of the main data of the addition data generated by the information processing apparatus (server) may be smaller than N. In this case, the information processing apparatus uses null packets, which have no data, to perform processing for adjusting the number of total packets in one AV stream file to N.

In addition, as another condition for an AV stream to be played back using the general playback control information 480, there is a condition that the I picture size is fixed to a predetermined size. The I picture size is information recorded to the clip information file. The I-picture-reading start position and the number of read bytes are recorded to the clip information file contained in the general playback control information 480. Specifically, data indicating the range of a packet position at which the I picture ends is recorded to an I_end_offset field in the clip information file.

In an example in which the clip information corresponding to an AV stream is set, as in the related art, it is sufficient if a value corresponding to the I picture size of an AV stream is recorded to a clip information file. However, one fixed I picture size is recorded to the clip information file contained in the general playback control information 480.

Thus, the data processing section in the information processing apparatus (server) performs processing for causing the I-picture-reading start position and the number of read bytes, the start position and the number being to be set for an AV stream file to be generated, to match the I-picture reading start position and the number of read bytes, the start position and the number being already recorded in the clip information file contained in the general playback control information 480.

When various pieces of content are encoded based on an MPEG standard, the resulting I pictures have various sizes. Accordingly, the data processing section in the information processing apparatus (server) for generating addition data obtains I-picture size information recorded in the clip information preset in the general playback control information and performs processing for matching the I picture size of an AV stream file with the size recorded in the clip information. More specifically, for example, by performing processing, such as embedding an arbitrary value in a user data file in MPEG data in which arbitrary data is settable, the data processing section performs processing for matching the size of I pictures in an AV stream with the size recorded in the clip information to generate an AV stream file containing I pictures having the defined size.

As described above, the data processing section in the information processing apparatus (server) for generating addition data generates one or multiple AV stream files, which are data files contained as playback data associated with the clip information. The data processing section performs processing so that the total playback time of packets in playback data contained in the generated AV stream file matches the playback time defined by the playlist contained in the general playback control information 480.

As described above, the playback start position defined by the clip information contained in the general playback control information is set to the position of the first I picture in an AV stream file containing playback data associated with the clip information. Thus, the data processing section in the information processing apparatus (server) generates an AV stream file containing playback data in which the first I picture of the AV stream file is set as the playback start position.

As described above, the information processing apparatus (server) generates an AV stream that is addition data, i.e., an AV stream file having a structure that allows playback using the general playback control information (i.e., that satisfies a certain condition), and supplies the generated AV stream file to the playback apparatus (the user apparatus).

The playback apparatus receives the AV stream file from the information processing apparatus (server), stores the received AV stream file on the local storage section, and performs playback processing on the AV stream file by using the general playback control information, i.e., the playlist, play items, and clip information which have a structure that is also usable for various addition data. The playback apparatus generates a virtual package by merging data stored on the information recording medium and the data stored on the local storage section and executes playback processing based on the virtual file system described above with reference to FIG. 5.

The present invention has been described above in detail with reference to the particular embodiments. However, it is obvious that those skilled in the art can make a modification and substitution to the embodiments in a scope without departing from the substance of the present invention. That is, the present invention has been disclosed by way of example and thus should not be construed as limiting. The scope of the claims should be construed in order to understand the substance of the present invention.

The series of processing described herein can be executed by hardware, software, or a combined configuration thereof. When the processing is executed with software, it can be executed by loading a program, in which the processing sequence is recorded, into an in-computer memory built into dedicated hardware or installing the program onto a general-purpose computer that is capable of performing various types of processing. For example, the program can be pre-recorded on a recording medium. The program can be installed to a computer from the recording medium. In addition, the program can be received through a network, such as a LAN (local area network) or the Internet, and be installed to a recording medium, such as an internal hard disk.

The various types of processing described herein not only include processing that is time-sequentially executed according to the described sequence but also include processing that is concurrently or individually executed according to the throughput of an apparatus that executes the processing if necessary. The term “system” herein refers to a logical combination of a plurality of apparatuses and is not limited to a system in which individual apparatuses having configurations are included in the same housing.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
a data processing section configured to generate data that is capable of being played back using general playback control information containing clip information defining the number of playback packets,
wherein the data processing section generates a data file in which data containing a number of playback packets, the number matching the defined number of playback packets, is contained as playback data associated with the clip information.

2. The information processing apparatus according to claim 1, wherein the data processing section performs processing for causing the number of playback packets contained in the playback data associated with the clip information to match the defined number of playback packets, by inserting a null packet.

3. The information processing apparatus according to claim 1, wherein the clip information contained in the general playback control information defines an intra-picture reading start position and the number of read bytes, and the data processing section generates a data file in which moving-picture-experts-group data having an intra picture that is compliant with the defined intra-picture reading start position and the defined number of read bytes.

4. The information processing apparatus according to claim 3, wherein the data processing section performs processing for causing the number of read bytes for the intra picture to match the defined number of read bytes, by performing processing for embedding an arbitrary value in a user data field in the moving-picture-experts-group data.

5. The information processing apparatus according to claim 1, wherein the data processing apparatus generates at least one audio visual stream file that is a data file contained as playback data associated with the clip information, a total playback time of packets in the playback data contained in the generated audio visual stream matching a playback time defined by a playlist contained in the general playback control information.

6. The information processing apparatus according to claim 1, wherein a playback start position defined by the clip information is a position of a first intra picture in an audio visual stream file containing playback data associated with the clip information, and
the data processing section generates an audio visual stream file containing playback data set so that a first intra picture in the audio visual stream file is a playback start position.

7. The information processing apparatus according to one of claims 1 to 6, wherein the information processing apparatus further comprises a communication section that transmits the data file generated by the data processing section to a user apparatus that performs data playback processing using general playback control information.

8. An information processing system comprising:
a playback apparatus that executes data playback processing; and
a server that supplies a data file containing data to be played back to the playback apparatus;
wherein the playback apparatus includes
a storage section on which the data file supplied from the server and a general playback control information file that is usable as playback control information that is common to different data files are stored, and
a data processing section that executes data playback processing by constructing a virtual file system in which data stored on the storage section and data stored on an information recording medium are merged, wherein during modification of a data file to be played back using the virtual file system, the data processing section performs virtual-file-system update processing that involves only modification of the data file without modifying the general playback control information file; and
the server generates a data file containing data having a structure corresponding to playback-data definition information contained in the general playback control information file and supplies the generated data file to the playback apparatus.

9. An information processing method executed by an information processing apparatus, the information processing method comprising a step of:
causing a data processing section to generate data that is capable of being played back using general playback control information containing clip information defining the number of playback packets,
wherein, in the data generating step, a data file in which data containing a number of playback packets, the number matching the defined number of playback packets, is contained as playback data associated with the clip information is generated.

10. A program that causes an information processing apparatus to execute data generation processing, the program comprising a step of:
causing a data processing section to generate data that is capable of being played back using general playback control information containing clip information defining the number of playback packets,
wherein, in the data generating step, a data file in which data containing a number of playback packets, the number matching the defined number of playback packets, is contained as playback data associated with the clip information is generated.
